(19) United States
(12) Patent Application Publication
(10) Pub. No.: US 2025/0267105 A1
(43) Pub. Date: Aug. 21, 2025

(54) Adaptive Ensemble Classification for Network Traffic Identification

(71) Applicant: The University of Chicago, Chicago, IL (US)

(72) Inventors: Nick Feamster, Chicago, IL (US); Francesco Bronzino, Lyon (FR)

(21) Appl. No.: 19/057,563

(22) Filed: Feb. 19, 2025

Related U.S. Application Data
(60) Provisional application No. 63/555,724, filed on Feb. 20, 2024.

(51) Int. Cl. H04L 47/2441; H04L 41/16

(52) U.S. Cl. CPC H04L 47/2441; H04L 41/16

(57) ABSTRACT

An embodiment may involve determining a network traffic rate for a link; determining an amount of available memory for classification in a computing system operationally coupled to the link; selecting a classifier from a plurality of classifiers, wherein the classifiers are respectively associated with a time usage and a memory usage, wherein the classifiers were trained to predict network traffic types based on network traffic flows, and wherein the selection is based on: the network traffic rate, an amount of available memory, and the time usage and the memory usage of the classifier; and deploying the classifier to receive incoming network traffic flows by way of the link.

### CROSS-REFERENCE TO RELATED APPLICATION

This application claims priority to U.S. Provisional Patent Application No. 63/555,724, filed Feb. 20, 2024, which is hereby incorporated by reference in its entirety.

### BACKGROUND

Network traffic classification is a practice in network management that involves identifying the services and applications being used on network (e.g., Internet) infrastructure. Traffic classification enables network operators, such as Internet Service Providers (ISPs), to carry out network operations, such as to monitor bandwidth utilization to prioritize certain subsets of traffic (e.g., for latency-sensitive applications) to ensure quality of service (QOS) or avoid network congestion, for capacity and resource planning, or to detect malicious traffic, and more. Efficient, accurate traffic classification is thus desirable for effective network operations.

### SUMMARY

Early network traffic classification solutions relied on heuristics developed by domain experts who derived the necessary features to infer traffic categories. Due to their simple nature, the total amount of time they required to preprocess extracted traffic data, feed the processed data to the classification method, and provide a classification answer was low. This amount of time is referred to as the time-to-decision (TTD), i.e., the end-to-end time from incoming traffic to a classifier decision.

Unfortunately, as the Internet evolves (and, in particular, as traffic is increasingly encrypted) and consolidates (i.e., services are operated by fewer infrastructure providers), many of these classifiers have become less accurate and difficult to maintain as the derived features become unavailable or less informative and quickly out of date.

Advances in machine learning (ML) techniques have enabled new classification methods that address some of the limitations of heuristic solutions. One class of ML-based classification models are flow-statistics-based methods. Similar to heuristic-based methods, these classifiers often rely strictly on engineered features and have the advantage of being fast at feature computation, making them good candidates to handle high network traffic volume with fast classification speed and minimal memory overhead. Unfortunately, they also share the limitations of previous methods, suffering from deteriorated performance upon traffic pattern changes and the Internet architecture evolutions at large.

To improve the classification performance, i.e., model accuracy, of existing solutions and overcome the problems of features availability due to the increasing prevalence of encrypted traffic payloads, some approaches that employ representation learning-based methods have been developed to classify traffic based directly from raw packet captures. A common characteristic (and often, drawback) of these classifiers is that they pay less attention to their practicality in handling realistic network traffic volumes under computational resource constraints. Thus, despite their high classification performance, they cannot satisfy the scale and bandwidth requirements of modern networks, becoming irrelevant against faster traffic rates.

Various implementations disclosed herein overcome these and possibly other technical problems by providing techniques for adaptive constraint-driven traffic classification.

In particular, the techniques herein address the trade-off between achieving high classification performance metrics coupled with the ability to meet the resource demands imposed by the larger networks they are be deployed within. To accomplish this, the techniques herein consider the practical deployment setting of a traffic classifier. In general, an ML-based classifier includes (1) a preprocessing component that transforms raw features into ML-usable input formats, and (2) an attached trained model that makes inferences using the preprocessed data. The efficiency bottlenecks of packet-capture classifiers often lie in the preprocessing component, where large amounts of required raw traffic features are in need of transformation, rather than the actual model inference stage.

Some approaches aim to overcome the trade-offs by enhancing packet-capture classifiers' throughput via tactics such as adjusting the complexity of the learning algorithm and the feature representation used. Although these strategies may improve the time-complexity of the model execution component of the TTD, the preprocessing of selected features remains the main bottleneck. Furthermore, the high memory overhead associated with implementing these classifiers is often neglected, which is also a consideration for practical deployment. Thus, the techniques herein take an ensemble approach to provide a balance between classification performance and efficiency, and achieves high classifier performance while meeting system requirements by implementing three key contributions.

First, rather than yielding a single classifier that demands fixed features, the techniques herein maintain a pool of classifiers with different feature requirements to allow for variations in the classification speed and memory utilization. This approach diverges from conventional ensemble practices in machine learning, where multiple algorithms are utilized to address potential variations in data distributions. Instead, the focus is on providing flexible choices for the feature requirements to adapt to traffic volumes and accommodate varying system resource constraints.

Second, the techniques herein include a heuristic-based feature exploration method that is not only designed for high classification performance, but also prioritizes low system overhead (e.g., memory efficiency), producing feature combinations that exhibit a reasonable trade-off between performance and efficiency. The method uses approximation techniques to quickly identify the most relevant features, enabling the generation of a more robust and efficient set of classifiers.

Thirdly, the techniques herein compute and preserve the classification performance, TTD, and memory utilization for each classifier at various batch sizes (i.e., the number of flows to collect and extract features from) before ingesting the flows and executing an instance of the classifier. By facing different traffic rates and memory availability on a given network link, the techniques herein implement an adaptive scheduler that leverages the measured information to select the optimal classifier and batch size that (1) satisfies the current memory availability and traffic rate, and (2) provides the ideal balance between performance and efficiency.

The techniques herein are evaluated on a dataset of traffic flows spanning a variety of applications and services. The results indicate that the techniques herein remain robust under various traffic rates and memory constraints. Meanwhile, they consistently balance the trade-off between model performance and efficiency by outperforming conventional packet-capture classifiers by orders of magnitude in terms of throughput while largely preserving classification performance that is substantially higher than classifiers based on flow statistics.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect is a computer-implemented method that includes determining a metric relating to features of network packets, where the metric for each respective feature of the features is based on a ratio between: a feature importance for the respective feature, and a subset of header bits that define the respective feature in the network packets. The method also includes determining a plurality of classifiers to train based on a set of selected feature combinations for each of a set of feature sizes, where the selected feature combinations are those with a highest sum of ratios per each of the feature sizes. The method also includes training the plurality of classifiers to predict network traffic types based on their respective sets of selected feature combinations. The method also includes evaluating performance of each of the classifiers based on: collecting raw features from batches of network traffic flows, executing each classifier iteratively on the batches, and evaluating time usage and memory usage of each classifier to predict network traffic types for the network traffic flows in the batches. Other embodiments of this aspect include corresponding computer systems, apparatus, and computer programs recorded on one or more computer storage devices, each configured to perform the actions of the methods.

Another general aspect is a computer-implemented method that includes determining a network traffic rate for a link. The method also includes determining an amount of available memory for classification in a computing system operationally coupled to the link. The method also includes selecting a classifier from a plurality of classifiers, where the classifiers are respectively associated with a time usage and a memory usage, where the classifiers were trained to predict network traffic types based on network traffic flows, and where the selection is based on: the network traffic rate, an amount of available memory, and the time usage and the memory usage of the classifier. The method also includes deploying the classifier to receive incoming network traffic flows by way of the link. Other embodiments of this aspect include corresponding computer systems, apparatus, and computer programs recorded on one or more computer storage devices, each configured to perform the actions of the methods.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates classifier steps, in accordance with example embodiments.

FIG. 2A illustrates packet size for different applications, in accordance with example embodiments.

FIG. 2B illustrates time-to-decision (TTD) at different traffic rates, in accordance with example embodiments.

FIG. 2C illustrates memory requirements at different traffic rates, in accordance with example embodiments.

FIG. 3 illustrates a classification pipeline, in accordance with example embodiments.

FIG. 4A illustrates a table of features, in accordance with example embodiments.

FIG. 4B illustrates a table of features, in accordance with example embodiments.

FIG. 5 illustrates a table of classifiers, in accordance with example embodiments.

FIG. 6A illustrates results of a classification throughput test, in accordance with example embodiments.

FIG. 6B illustrates a table with performance results, in accordance with example embodiments.

FIG. 7A illustrates memory requirements at different flow rates, in accordance with example embodiments.

FIG. 7B illustrates memory requirements at different flow rates, in accordance with example embodiments.

FIG. 8 illustrates performance for TTD versus performance for several classifiers, in accordance with example embodiments.

FIG. 9A illustrates memory utilization and batch size at different memory availabilities, in accordance with example embodiments.

FIG. 9B illustrates batch size at different traffic rates, in accordance with example embodiments.

FIG. 10 is a flow chart, in accordance with example embodiments.

FIG. 11 is a flow chart, in accordance with example embodiments.

FIG. 12 illustrates a schematic drawing of a computing device, in accordance with example embodiments.

FIG. 13 illustrates a schematic drawing of a server device cluster, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Evaluation of Traffic Classification Methods

Network traffic classification is a continuous process that commences with the interception of Internet traffic and ends with grouping the traffic into predefined categories, e.g., normal/abnormal traffic or specific services/applications.

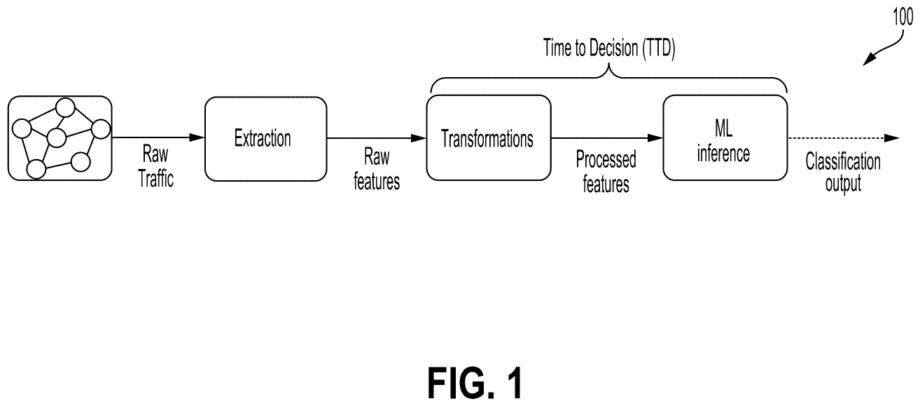

FIG. 1 illustrates the steps 100 involved in network traffic classification. These steps encompass initial operations, such as extracting raw features from the captured raw traffic, and machine learning (ML)-oriented procedures, including converting these raw features into a format suitable for ML and using trained models to perform inference on flows with the processed features. Two types of ML-based classifiers and their performance are discussed below.

Flow-statistics classifiers are ML-based approaches for traffic classification, which are often inspired by heuristics-based techniques as discussed above. These classifiers typically involve the use of computed statistics from traffic flows to make predictions, e.g., throughput, packet inter-arrival times, etc. A representative flow-statistics classifier using Gaussian Mixture Model (GMM) clustering was used to perform a classification task using the packet sizes and inter-arrival times of the first four non-zero size packets of the TCP connections of traffic flows.

Some other ML-based traffic classifiers make use of increased computational power, ingesting raw traffic contents, e.g., packet captures facilitated by a packet capture (PCAP) library, as inputs. This approach allows a more in-depth analysis of network traffic, thereby providing a comprehensive understanding of hidden patterns and characteristics that can aid in accurate traffic classification. To this end, the same classification task can be performed using a packet-capture-based method on a one-dimensional convolutional neural network (CNN) classifier. In this classifier, only the first three packets of each flow are provided as inputs. This occurs because learning from the initial three packets from the flows already allows for the classifier to achieve F1 scores well above 0.9 (where F1 scores are based on the harmonic mean of precision and recall metrics, and higher scores indicate better performance). This may involve feeding the first 1500 bytes (including the IP header) of each packet into the classifier and, as the CNN initially performs packet-level classification, the majority vote of the three packet-level predictions was taken to arrive at a flow-level classification decision.

An assessment of the above classifiers was performed by training and testing them on a curated dataset consisted of near 20,000 individual flows spanning across ten different applications. The dataset is divided into train/test sets using a 50/50 split, with a relatively larger test set compared to the conventional 80/20 split. The split is performed in this way because the evaluation emphasizes not only performance but also the efficiency of the classifiers during the classification process, which benefits from a sufficiently large test set.

The traffic rate is varied from 10 to 7,000 flows/second by randomly sampling specified numbers of flows from the test set and examine classifiers' performance and efficiency in terms of weighted F1 score, TTD, and in-use memory. Traffic rate in this study indicates the number of flows per second for which the system is able to capture and extract raw features. As these conventional classifiers do not elaborate on the explicit number of flows that are required to be captured before initiating a new instance of the classifier, i.e., the batch size, it is assumed for sake of testing that a new instance of the classifier is initiated every second to classify all traffic received in the previous second.

The results of the assessment are illustrated in Table 1 below:

TABLE 1

| | | Efficiency | |
|---|---|---|---|
| | | | Memory |
| | Performance | | Requirements |
| Classifier Type | F1 score | TTD (s) | (GB) |
| Flow-statistics | 0.391 | 0.023 | 0.503 |
| | | (76.3% feature | |
| | | preprocessing) | |
| | | (23.7% model execution) | |
| Packet-capture | 0.977 | 19.689 | 82.463 |
| | | (74.7% feature | |
| | | preprocessing | |
| | | (25.3% model execution) | |

As illustrated in Table 1, the evaluation shows that the flow-statistics GMM classifier has an average F1 score of 0.391, significantly lower than the packet-capture-based classifier with an average F1 score of 0.977. This result is expected because the flow-statistics GMM classifier generally cannot fit the complex underlying distribution of the data using the few provided features.

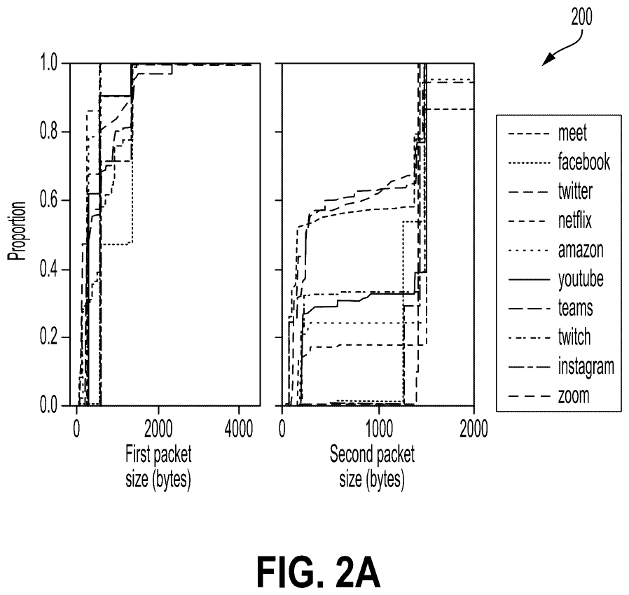

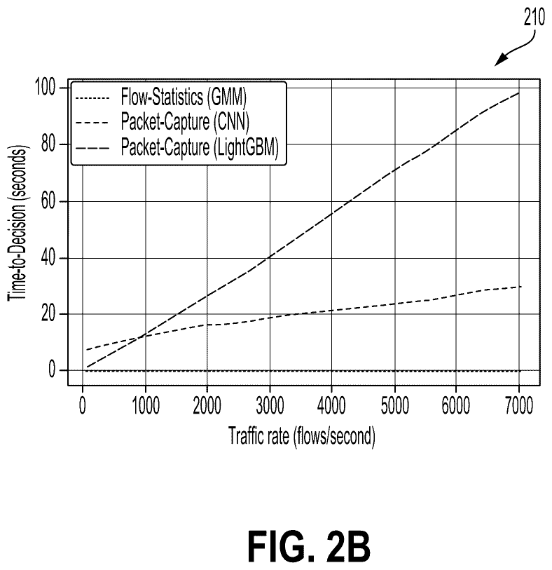

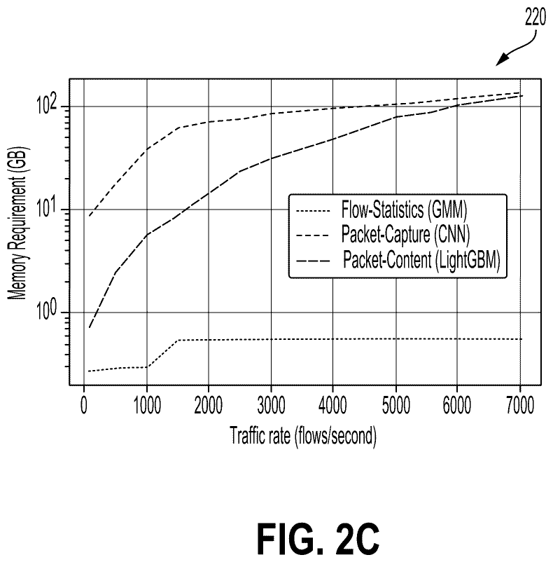

The features used by the flow-statistics GMM classifier also become less informative, which also reduces the classification performance. For example, the size information becomes less distinctive. For the second packet, 56.27% of flows across 10 applications share similar sizes around 1500 bytes (as shown in the graph 200 of FIG. 2A).

On the contrary, packet-capture classifiers tend to exhibit higher classification performance, due to the abundance of learnable features and the capability to automatically identify informative features without the need for manual feature selection. But Table 1 shows that the packet-capture classifier exhibits average TTD that is ˜855× higher than the flow-statistics-based GMM. To understand where the majority of time is spent, the TTD was split into the proportion of time required to process the features (feature preprocessing) vs the time to execute the inference model (model execution). As shown, for both classifiers, the TTD bottlenecks are largely caused by high feature preprocessing time, rather than at the model execution/inference steps. For both classifiers, the average model execution time never exceeds 30% of the total TTD. While Table 1 reports the average results in these efficiency trade-off analyses, fine-grained comparisons at all evaluated traffic rates are depicted in graphs 210 and 220 of FIGS. 2B and 2C, respectively. The observed trends across various traffic rates remain relatively consistent as the reported average results.

The memory requirement in Table 1 refers to the additional memory consumption incurred by the classifiers beyond the raw feature extraction, including storing intermediate features during preprocessing, loading trained models for classification, and generating final predictions. When dealing with a high volume of traffic, multiple instances of the classifiers are likely to be running in order to mitigate delays and potential buffer overflow. Thus, this disclosure defines the memory requirement of the classifier as the minimum system memory necessary to support the concurrent execution of multiple instances of the classifiers to support the specified traffic rate.

As depicted in Table 1, on average, the packet-capture-based CNN utilizes ˜163× more system memory than the flow-statistics-based GMM. This difference is anticipated as the feature space and computation complexity of the packet-capture classifiers are significantly higher, resulting in substantial increases in memory overhead. These results echo that generic packet-capture classifiers might incur in memory violations if deployed on systems that are not equipped with the required on-board memory.

Overall, considering the comparison results presented, there exist trade-offs between flow-statistics and packet-capture classifiers in terms of performance and efficiency. The aim of the techniques described herein is to balance these trade-offs by introducing a new traffic classification framework to retain high performance of packet-capture classifiers while achieving better efficiency, approaching that of flow-statistics classifiers.

### II. Adaptive Constraint-Driven Classification

The above evaluations of existing classifiers shows that a significant portion of the efficiency overhead in network traffic classifiers stems from the need to preprocess raw features to attain high classification performance. Nevertheless, when dealing with large volumes of network traffic, it may be acceptable to make small sacrifices in classification performance to achieve higher efficiency so that the classifier can function properly. And, under varying system constraints, it is beneficial to balance performance and efficiency without unnecessarily compromising on either metric.

To address these and other problems, this disclosure proposes a framework for Adaptive Constraint-Driven Classification (ACDC). ACDC leverages an ensemble approach by curating a pool of classifiers, each with varying feature requirements and, therefore, different performance-efficiency trade-offs. This ensemble approach is unique because it concentrates on modifying the feature specifications to relying on a collection of ML algorithms to accommodate diverse data distributions. This empowers users of such classifiers to make an informed decision on selecting the most suitable classifier with different feature requirements to implement, based on the computational resources and traffic volume that are available at the time.

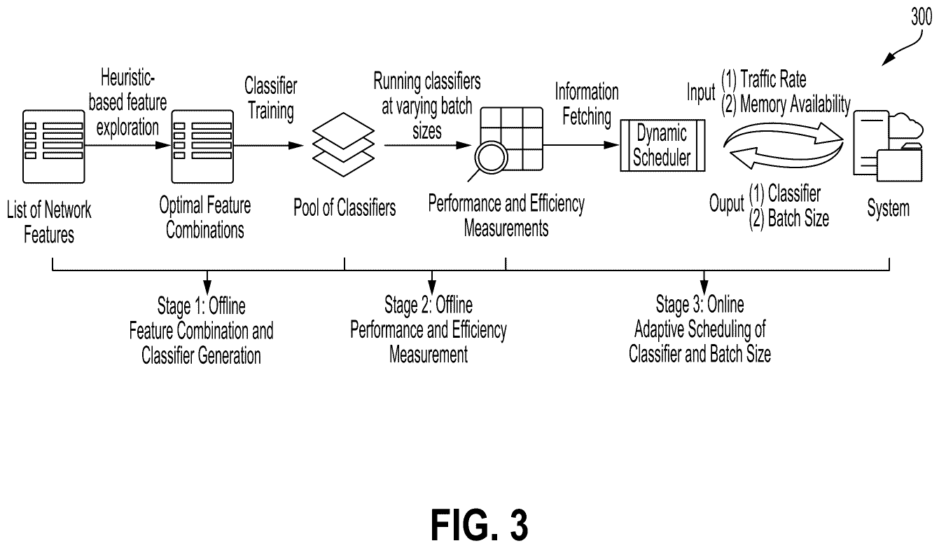

As illustrated in steps 300 of FIG. 3, the ACDC framework includes a three-stage pipeline with the following components: (1) an offline bootstrapping stage that uses a heuristic feature exploration algorithm to approximate the optimal feature combinations for a balance between performance and efficiency; this stage generates a pool of classifiers, each with different feature requirements as determined by the outcome of the feature exploration algorithm; (2) an offline stage that measures the actual performance and efficiency of the classifiers at different batch sizes when deployed on the implementing system; and (3) an online classification stage which employs an adaptive scheduler to continually monitor current traffic rates and memory availability to select the most suitable classifier and batch size for classification.

For reference, the performance of all classifiers herein is computed using the F1 score. In some embodiments, this performance metric can be replaced with any other desired metric, depending on the specific application targets, e.g., to prioritize recall to avoid false negatives.

As shown in FIG. 1, time-to-decision (TTD) is defined as the total elapsed time from the initiation of the feature preprocessing step to the conclusion of the model inference step, that is, when classification decisions have been made on all flows. TTD is a useful metric for classification frameworks when deployed in networking systems because large TTDs can force systems to lose packets or not have the required information in time. In order to obtain accurate TTD measurements, unnecessary outputs and functionalities in the classifiers are removed, such as progress logging and metadata storage. To reflect realistic time consumption, I/O times for intermediate steps, such as loading extracted raw features, are included. In the case of ACDC, the classifier switching time is also considered in the TTD. Raw feature extraction times in the TTD are not considered in the TTD because the feature-extraction process tends to be relatively fast and the techniques used for extraction vary among network system implementers, making it difficult to conduct a fair comparison across different tools.

Memory requirements of the classifiers are not measured by referring to their total memory allocations under no memory constraint because such allocations reflect the ideal but not minimum memory requirements. Instead, the memory requirement is defined herein as the minimum amount of RAM and swap memory that is necessary for the classifier instance to function normally. This includes ensuring that (1) the classification processes are not terminated prematurely and (2) the TTD does not increase due to insufficient memory availability.

When multiple instances of the classifier are running in parallel, the aggregated minimum memory requirement to support concurrent execution of all instances is calculated. To determine such minimum memory requirements, Linux memory control groups (cgroup) may be used to impose limitations on the amount of memory available to the classifier instance. Subsequently, a binary search algorithm may be used to iteratively reduce memory usage to the smallest amount that does not cause the instance to behave abnormally.

### A. Heuristics-Based Feature Exploration and Classifier Generation

The performance and efficiency of network classifiers stems as much from the model in use as from the features that are fed to it. In the first stage of its pipeline, ACDC selects candidate features across a large list of available ones to generate a pool of candidate classification models.

To carry out any feature exploration, models may establish an initial set of network-level features. Further a tool for selective preprocessing of specified subsets of the features from raw traffic captures into machine-learning-compatible representations may also be used. In this specific implementation of ACDC, features are defined using the header fields of the flow packets, e.g., IPV4_TTL, TCP_OPT, etc, and use nPrint to generate the required network data representations. This is because nPrint supports an easily accessible packet header field subscription interface. In this representation, each packet of the flows is encoded into a normalized, binary format preserving the underlying semantics of each packet. In some embodiments, nPrint may be substituted with any desired network traffic encoder without disrupting the functionality of the ACDC framework.

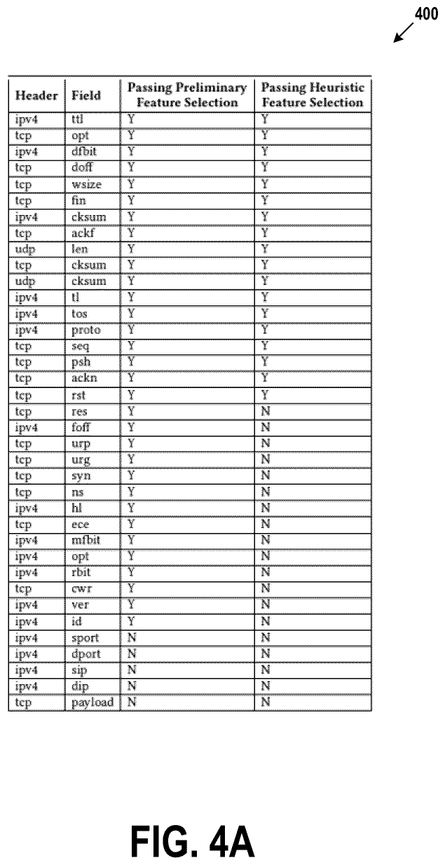

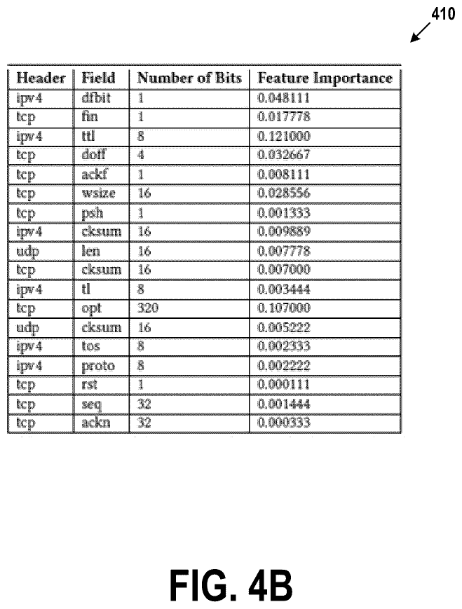

Herein, 37 individual features are defined, which include the IPV4, TCP, and UDP header fields as well as the packet payload. The packet payload is removed because all testing traffic is encrypted with transport layer security (TLS) and the payload should only contain noise that does not contribute to the classification task. All noticeable fields that may contribute to model over-fitting, including the IP addresses and ports for both ends of the connections are also removed. Only the header fields from the first three packets in each flow are used as they produce sufficiently good performance. After this preliminary feature selection, an initial list of 32 features that are available to use for feature exploration and generating the pool of classifiers is produced. A detailed list of the 37 initial features and the 32 features that passed preliminary selection is illustrated in table 400 of FIG. 4A. The number of initial and selected features may vary, and the examples provided herein are for purposes of illustration.

Once candidate features are selected, the ACDC framework identifies feature combinations to create candidate classifiers with high (1) performance-to-TTD and (2) performance-to-memory requirement ratios. The goal is to identify candidate classifiers that strike a good balance between performance and efficiency. Traditional feature selection techniques are not ideal for this task as they are primarily designed for identifying small feature subsets with high performance, while ignoring efficiency considerations. Additionally, they typically eliminate correlated features. However, in our scenario, correlated features may still be appropriate if they improve classification performance with minimal efficiency overhead. A naive approach is to explore all possible feature combinations and select the top feature subsets that yield the highest ratios. However, this would entail a massive feature exploration space that requires training and evaluation of Σₖ₌₁³² (32/k) classifiers, which is impractical.

To address this challenge, two observations are made: (1) when training the model that includes all 32 preliminarily selected features and looking at the permutation shuffling feature importance, there is a strong correlation (coefficient of 0.753) between feature importance and the marginal improvement in performance achieved by making each feature available to the classifier, and (2) there exists a strong correlation (coefficient of above 0.99) between the aggregated number of bits in a feature subset and the corresponding efficiency overhead in terms of TTD and memory requirements.

Given these observations, the expected performance and efficiency changes can be approximated when incorporating a feature into the model's feature set. Thus, the previous mentioned optimization ratios can be abstracted by considering the ratio between the aggregated feature importance and number of bits for any given feature subsets.

Feature importance is model-dependent and comes from how the model internally ranks features, such as Gini importance in decision trees or coefficients in linear models. It can be biased toward certain feature types and may not fully capture interactions. Permutation importance, on the other hand, is model-agnostic and works by shuffling a feature's values and measuring the drop in model performance, providing a more reliable measure of a feature's actual contribution. Either feature importance or permutation importance can be used herein to estimate the importance of a feature. Thus, the term “feature importance” may refer to either.

These findings can be leveraged to construct a heuristic-based algorithm to generate feature subsets that works as follows. For each feature, its permutation feature importance (FIᵢ) and total number of bits Bitsᵢ are computed. The ratio

$$\frac{{FI}_{i}}{{Bits}_{i}}$$

is then calculated and features are ranked based on the calculated ratio. A list of features after this step is illustrated in table 410 of FIG. 4B.

The size of the desired pool of candidate classification models is then determined using two parameters: sizes, a set of feature requirement sizes to consider; and num_{combos}, number of different combinations to generate at each feature requirement size. Thus, the total number of classifiers is pool_size=len(sizes)·num_{combos}, which is the number of feature requirement sizes multiplied by the number of combinations.

Finally, for each feature requirement size n in the set of sizes, num_{combos} distinct combinations of n features with the highest sum of

$$\frac{{FI}_{i}}{{Bits}_{i}}$$

ratios are iteratively found. This procedure yields a set of feature subsets with size equal to pool_size and they are subsequently used as distinct feature requirements to generate the pool of classifiers.

For example, if sizes={2, 3} and num_{combos}=4, then a total of 8 classifiers are trained. Of these classifiers, 4 are trained with different combinations of two features, and 4 are trained with different combinations of 3 features.

The heuristic-based procedure described above offers several advantages over an exhaustive search approach: firstly, its time complexity is bounded by the desired pool_size, which results in a significantly reduced computational load compared to exhaustive search. Secondly, the proposed heuristic algorithm eliminates the need for training, testing, and evaluating excessive amounts of classifiers during the feature subset derivation process, thereby further reducing the computational burden. Finally, the computed feature subsets are also skewed toward the performance-to-efficiency ratio per the strong correlations discovered through the observations.

The computed feature subsets may then be used as the feature requirements to generate the classifiers in the pool of candidate classification models. The specific choice of the ML algorithm is less significant for each classifier, as long as it is consistent with a baseline value. Herein, LightGBM is used as an example model to provide comparable results to the nPrintml-based LightGBM baseline introduced below. For each feature requirement, nPrint is used to preprocess the specified features and then feed them into the training of a LightGBM model to complete the generation of the classifier.

### B. Performance and Efficiency Measurements at Varying Batch Sizes

Upon obtaining the pool of classifiers created at the previous stage, detailed metrics on their performance and efficiency are gathered by executing the classifiers in the pool at various batch sizes. The concept of batch sizes is enforced by storing extracted raw features from the test set for a number of flows equivalent to the batch size into a designated location. Then, classifier instances are initiated to preprocess and make predictions on all the raw features in a single batch.

In general machine learning, the batch size is a hyperparameter that determines the number of samples to gather before initializing an instance of the classifier to do a bulk preprocessing and classification on all input samples. Herein, the batch size refers to the number of traffic flows to collect raw features from before calling the classifier instance. As shown above where the batch size is equal to the traffic rate, increasing batch sizes can greatly impact the TTD and memory requirements, particularly for packet-capture classifiers.

If the concept of batch size is not taken into account and classifiers are run periodically, for example, once per second, the associated efficiency overhead can become excessively high when the traffic rate is high. As a result, measurements are collected on the classifiers at varying batch sizes during the offline bootstrapping phase which can subsequently be utilized by an adaptive scheduler to make informed decisions when selecting the most appropriate classifier and determining a batch size.

With a pre-determined batch size, it is possible to have multiple instances of a classifier running in parallel. This occurs when the TTD of a classifier instance is greater than the time required to fill up the batch size but enough system memory is available to execute concurrent instances of the model. To determine the memory requirement necessary to execute two or more models concurrently, required memory as the aggregate memory needed to support concurrent execution of all the classifier instances without any failure or delay was evaluated.

Provided with any batch size B and classifier C, the (1) end-to-end time TTD_{C}(B) it takes for the classifier to arrive at the prediction, and (2) the unit memory requirement m_{C}(B) for running one instance of C can be measured. Sequentially, given batch size Bₜ and traffic rate Rₜ at time Tₜ, the maximum possible number of concurrently running instances of any classifier C with TTD_{C} can be formulated as

$${N}_{t} ( {B}_{t} , {R}_{t} , {TTD}_{C} ) = ⌈ \frac{{TTD}_{C} ( {B}_{t} )}{{B}_{t} / {R}_{t}} ⌉ ,$$

and the total memory requirement can be expressed as Mₜ(Nₜ, m_{C})=Nₜ·m_{C}.

Given any classifier instance with a trained model and a predetermined batch size, its total memory requirement can be calculated according to the above formulation. For example, an evaluation of the existing classifiers where the batch size is by default equal to the traffic rate at all time, their total memory requirement can be simply expressed as ┌TTD_{C}(Bₜ=Rₜ)┐·m_{C}(Bₜ).

### C. Adaptive Scheduler

Given the generated pool of classifiers and their corresponding measurements, an adaptive scheduler can be used to observe the incoming network traffic rate and memory availability, and output a selected classifier and a selected batch size with the reasonable balance between performance and efficiency.

Facing any traffic rate, the aim of the adaptive scheduler is to determine the combination of classifier and batch size that balances high performance with low TTD. To translate this goal into an executable optimization function, the scheduler employs an iterative approach to search through the performance and efficiency measurements and return the combination of classifier and batch size with the highest performance-to-TTD ratio.

Since the scheduler is generally configured to locate the classifier and batch size that yield to the highest performance-to-TTD ratio, it seeks for a balance between the two metrics but does not necessarily guarantee a lower bound on the final performance. In practical deployments, implementing parties may have a minimum acceptable performance that they require in their classification tasks. As a result, functionality is added to specify a minimum performance requirement (MPR) to the adaptive scheduler which proceeds to filter out any combination that does not meet the requirement. When no combination can meet the requirement, the scheduler defers to the one with the highest performance.

Pseudocode for an example scheduler process is provided below:

```
Input: traffic rate, mem availability
Data: performance/efficiency measurements
candidates←type (list)
for combination in Data do
  if total mem requirement for combination <= mem
availability then
    candidates.append (combination)
  end if
end for
if len (candidates) != 0 then
optimal_combination←candidates[0]
  for candidate in candidates do
    if candidate performance-to-TTD ratio > optimal
  combination performance-to-TTD ratio then
      optimal_combination = candidate
    end if
  end for
end if
Return optimal_combination
```

The above process describes the functionality of the adaptive scheduler after the MPR has been enforced. Given any constraint on the system memory resource, the scheduler observes the memory requirement of the combinations at the given traffic rate and filter out ones that result in a violation of memory availability. For example, if the memory availability is 5 GB and the traffic rate is 1500 flows/second, a combination with a classifier TTD of 1.5 seconds, a batch size of 500 flows, and a unit memory requirement of 1.5 GB is going to be eliminated as the total memory requirement, per the equations above is [1.5/(500/1500)]·1.5=6.75 GB which exceeds the availability.

After filtering out all such combinations, the scheduler conducts an iterative search procedure to identify the combination with the highest performance-to-TTD ratio. The resulting classifier and batch size determine how the incoming traffic flows are classified. As the traffic rate and memory availability change, the scheduler adjusts the chosen combination to adapt to the described ratio.

### III. Evaluation of Adaptive Constraint-Driven Classification

The performance of ACDC is evaluated herein against other classifiers. All classifiers are instructed to perform flow-level application classification on a carefully selected network traffic flow dataset. These experiments show that, under both memory-rich and memory-scarce environments, ACDC balances performance and efficiency, showing better classification results than the flow-statistics classifier while maintaining classification throughput higher than conventional packet-capture classifiers. The robustness of the framework is further demonstrated by profiling its behavior under varying traffic rates and memory availability.

There are many sources for network traces, such as the ISCX VPN-Non VPN traffic dataset, the CAIDA Anonymized Internet Traces, and the QUIC dataset. However, these datasets are relatively old and may not accurately reflect the current Internet topology, particularly concerning the studied services. Additionally, many of these datasets do not have clearly defined labels for the associated applications or services at the flow level, which is essential for evaluating classifier performance.

As a result, all classifiers are evaluated using the the curated dataset described in Table 2 below which consists of video streaming, video conferencing, and social media traffic flows spanning ten different applications and a wide range of collection dates.

TABLE 2

| Macro | Total No. | Application Labels | Collection |
|---|---|---|---|
| Services | of Flows | (No. of Flows) | Date |
| Video | 9465 | Netflix (4104) | 2018 Jun. 1 |
| Streaming | | You Tube (2702) | |
| | | Amazon (1509) | |
| | | Twitch (1150) | |
| Video | 6511 | MS Teams (3886) | 2020 May 5 |
| Conferencing | | Google Meet (1313) | |
| | | Zoom (1312) | |
| Social Media | 3610 | Facebook (1477) | 2022 Feb. 8 |
| | | Twitter (1260) | |
| | | Instagram (873) | |

The traffic is captured as PCAP files and cleaned by (1) examining the DNS queries to identify IP addresses relevant to the services/applications, (2) filtering out irrelevant traffic to contain only traffic associated with the applications/services using the identified IP addresses, and (3) separating traffic into individual flows using the 5-tuple attributes (source and destination IP, source and destination port, and the protocol field).

Application labels, such as Netflix or YouTube, are applied for each preprocessed flow to evaluate classification performance. The traffic from the above-mentioned datasets are all TLS encrypted and the aggregation of them are used as the general dataset for evaluating ACDC and the baseline classifiers.

ACDC optimizes the balance between performance and efficiency. While performance can be represented using the F1 score, it can be difficult to grasp the efficiency-related time-to-decision. To better present the results, the TTD is converted into classification throughput for all evaluated classifiers and batch sizes at different traffic rates and memory availability. Classification throughput here is defined herein as the number of traffic flows that a classifier can preprocess and make inference decisions on within one second after raw feature extraction. A higher classification throughput serves as an indicator of better time efficiency. For example, if raw features are extracted for 7,000 flows in one second and the classifier is able to process and make decisions on 5,000 of those flows in the subsequent second, then the classification throughput would be 5,000 flows/second, 71.4% of the traffic rate.

ACDC's classification throughput can be derived based on the measured TTD because the latter reflects the amount of time needed for the classification framework to complete preprocessing and inferencing on all flows collected in the previous second, i.e., lower TTD results in higher classification throughput. Formally, the classification throughput can be calculated as traffic_rate/TTD.

### A. Performance Under No Memory Constraint

The performance and efficiency of ACDC is first examined in resource-rich environments with abundant memory availability. The objective is to classify network flows at varying traffic rates, which range from 100 to 15,000 flows/second. Different traffic rates are emulated by aggregating randomly sampled flows from the test set. The flow-statistics classifier (GMM) is utilized to establish an upper bound for classification throughput because it is capable of preprocessing and classifying flows at the same rate as the incoming traffic within the range under evaluation.

Two classifiers are used as baselines for classification throughput to represent packet-capture classifiers. These include a Deep-Packet CNN classifier and an nPrintml-based LightGBM classifier that uses all 33 features. The LightGBM classifier is included as an additional example baseline as it uses the same preprocessing tool (nPrint) and ML model as the ACDC embodiment under evaluation. This enables the performance of a fair comparison with minimum bias from model and preprocessing tool selection. A CNN classifier is also included to demonstrate that the ACDC classification framework can provide better performance and efficiency trade-off compared to packet-capture classifiers with different preprocessing tools and ML models.

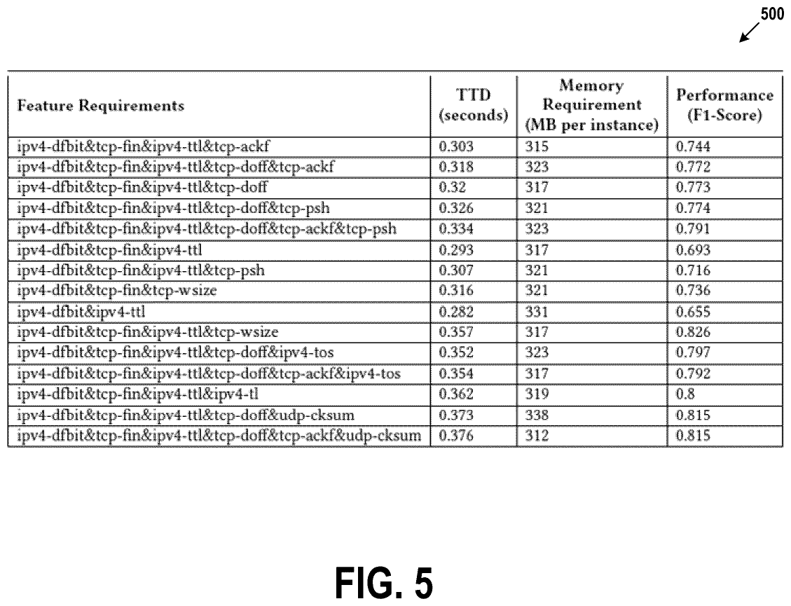

Feature requirement sizes ranging from one to nine with 10 different combinations at each size are considered, resulting in a pool of 90 distinctive classifiers each with different feature requirements. The maximum feature requirement size is set to nine, as increasing the maximum feature requirement size beyond nine creates classifiers and feature sets that are highly unlikely to be selected by the scheduler, i.e., features ranked 10th or below (by the heuristic algorithm) start to deviate towards significantly high overhead in face of low performance contribution. This is largely due to the chosen feature granularity and, with finer-grained features, the maximum feature requirement size can be increased accordingly. Example classifiers in the pool are listed in the table 500 of FIG. 5, ranked by the highest-performance-to-efficiency ratios at a selected batch size of 500 flows.

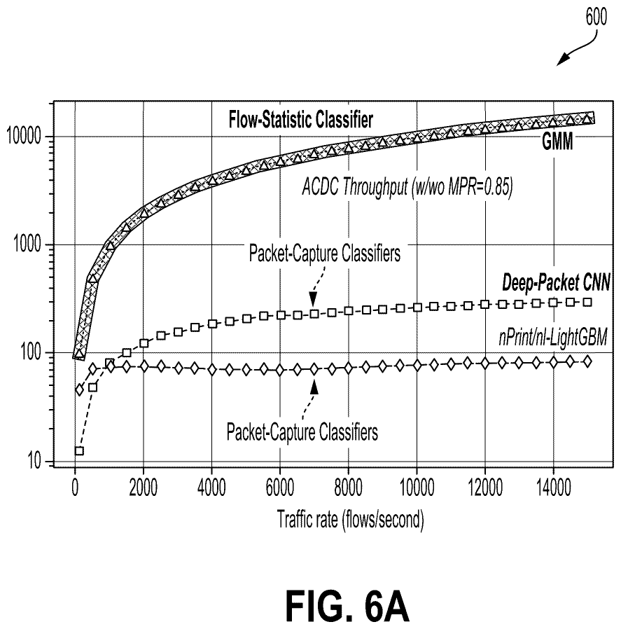

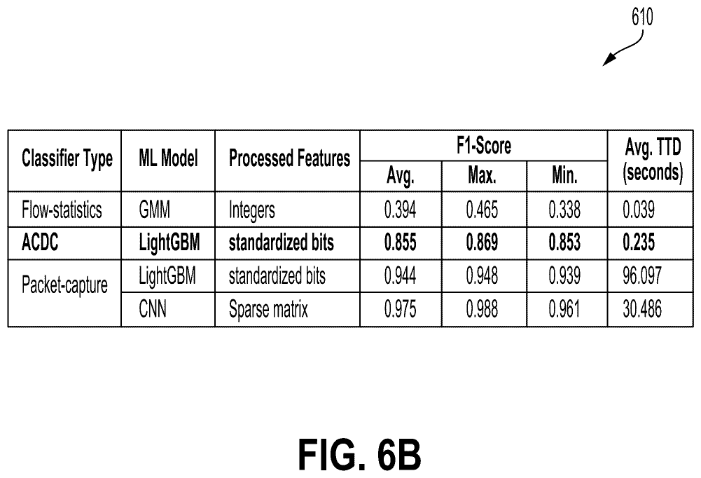

Results of the achieved classification throughput across the different classifiers are shown in graph 600 of FIG. 6A. These results indicate that the ACDC is able to match the throughput upper bound generated by the flow-statistics-based GMM and outperform the conventional packet-capture-based LightGBM and CNN by 176.95 and 48.98 times, as the traffic rate grows to 15,000 flows/second, respectively.

ACDC's classification throughput is evaluated both with and without the minimum performance requirement set at 0.85 in F1 score, and the framework meets the upper bound in both cases. In this scenario, the framework delivers consistently high classification throughput by selecting the classifier with the highest performance-to-TTD ratio at a batch size of one and initiating as many instances of the chosen classifier as required since no memory constraint is enforced. Thus, theoretically, the ACDC consistently sustains a high classification throughput given enough system memory, regardless of the increasing traffic rate.

The classification throughput, defined as the number of flows that a classifier can preprocess and generate final predictions for within a one-second time window following the extraction of raw features, may not always reflect the actual TTD. Despite achieving 100% traffic rate for classification throughput, the actual TTD may be less than one second. As observed from the table in FIG. 6B, the ACDC framework achieves the upper bound throughput but with a lower average TTD as compared to the flow-statistics classifier. However, it still outperforms the packet-capture classifiers with a substantially lower average TTD.

Using the table, ACDC's classification performance can be compared against existing classifiers. Overall, packet-capture classifiers have higher classification performance, while the flow-statistics-based GMM get the lowest F1 score. The minimum performance requirement for ACDC was first set at a F1 score of 0.85. The table 610 in FIG. 6B shows that ACDC achieves an average F1 score of 0.855, which is only 0.089 and 0.12 lower than the upper bound performance of LightGBM and CNN, respectively. More importantly, it outperforms the flow-statistics classifier by 117% in F1 score. When no minimum performance requirement is specified, ACDC still reaches an F1 score of 0.8 which is 103% higher than the flow-statistics classifier.

These results highlights that, under no memory constraint, ACDC is capable of outperforming packet-capture classifiers in terms of classification throughput and flow-statistic classifiers in terms of classification performance.

### B. Performance in Memory-Constrained Environment

The above results demonstrate that, with no memory constraint, ACDC achieves 100% classification throughput with high performance for the evaluated traffic rates. The next evaluation is regarding whether the framework can effectively maintain this balance even with low memory availability. The minimum memory that ACDC requires for functioning and maintaining a high 100% throughput that matches the incoming traffic rate is examined first. In the case of the baseline packet-capture classifiers, they experience low throughput even with unlimited memory availability as shown in FIG. 6A. Thus, their minimum memory requirements to support the maximum throughput they are able to achieve are measured. The evaluation starts with a traffic rate of 500 flows/second which gradually increasing up to 7,000 flows/second with a granularity of 500 flows/second.

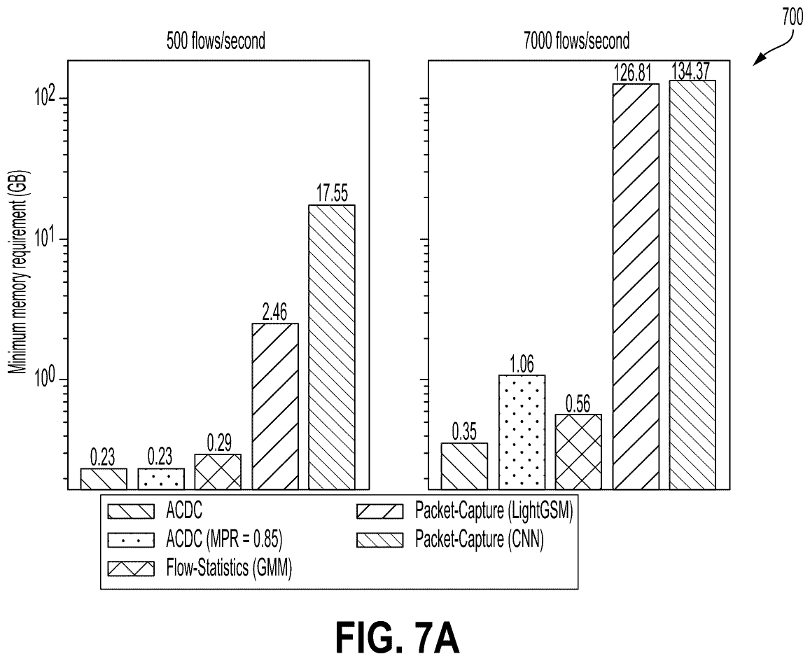

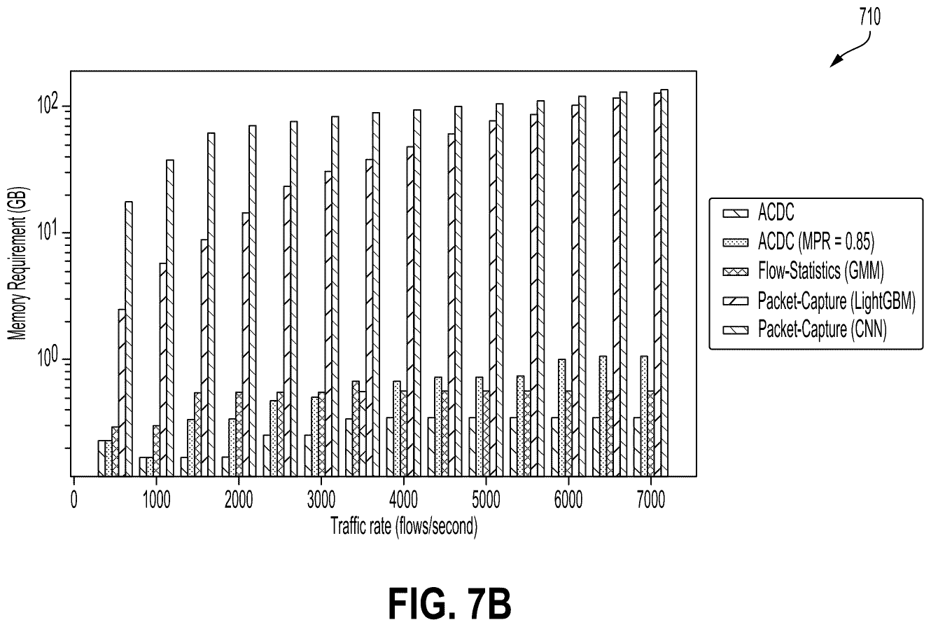

The results, as shown in graph 700 of FIG. 7A, demonstrate that the minimum memory requirements of ACDC are lower than those of both flow-statistics and packet-capture classifiers at the higher tested traffic rates (500 and 7,000 flows/second). In absence of any performance constraints on the ACDC framework, it is evident that ACDC is less prone to memory exhaustion and subsequent failures. This characteristic of ACDC makes it a more suitable option for deployments where memory availability is a limiting factor.

This phenomenon is partly due to heuristic-based classifier generation process, which aims to minimize TTD and memory requirements for all generated classifiers. Consequently, regardless of the classifier selected by the scheduler from the pool, the resulting memory requirement will be relatively low. Fine-grained minimum memory requirements are depicted in graph 710 of FIG. 7B.

Although the absence of a minimum performance requirement on ACDC results in minimized memory demands, it also leads to relatively low classification performance, with an average F1 score of 0.802. Thus, the efficiency of the framework is further explored by imposing a minimum performance requirement of 0.85 in F1 score. These results are also shown in FIG. 7A. With the added constraint, a slight increase in the overall minimum memory requirement for maintaining 100% throughput is observed, which grows higher than the flow-statistics classifier (starting at a traffic rate of 3,500 flows/second). This behavior is expected, as higher classification performance necessitates the selection of classifiers with more feature requirements, which occupy more memory during preprocessing and classification.

However, the resulting memory requirements are still close to those of the flow-statistics classifier and significantly lower than the packet-capture classifiers. At a traffic rate of 7,000 flows/second, ACDC's minimum memory requirement is 118.8× and 126× less than the nPrintml-LightGBM and Deep-Packet CNN classifiers, respectively.

After demonstrating that the framework is better-suited for environments with limited memory due to its relatively low memory requirements to sustain high performance and throughput, the results also establish that ACDC achieves a better balance between performance and efficiency when compared to the baseline classifiers. This was demonstrated by measuring the F1 score and TTD of the framework at varying traffic rates up to 15,000 flows/second. The framework is only allowed to access the minimum amounts of memory needed to sustain a 100% classification throughput.

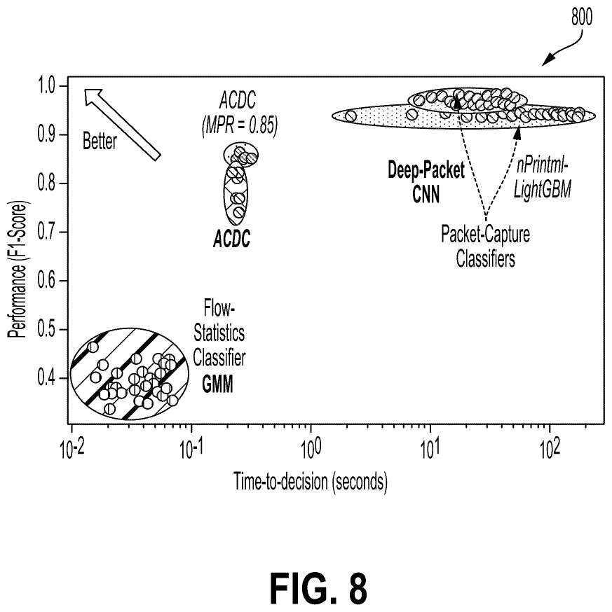

The results, shown graph 800 in FIG. 8, reveal that ACDC consistently balances between high F1 score and low TTD (i.e., high classification throughput). Unlike the baseline classifiers that typically exhibit either high F1 scores or low TTDs, but not both, ACDC is capable of choosing a better combination of classifiers and batch sizes that yields both high F1 score and low TTD without severely compromising on either metric. This is because the optimization goal enforced on the adaptive scheduler (discussed above) is designed to produce outcomes that lead to the highest performance-to-TTD ratio, as opposed to placing excessive emphasis on one metric over the other. At the same time, the curated pool of classifiers and the corresponding feature requirements are also pre-selected to maintain this balance.

### C. Performance Under Varying Memory Constraints and Traffic Rates

The performance of ACDC under changing memory constraints and traffic rates is also evaluated. This is to reflect realistic deployment scenarios where traffic rates (and hence memory demands) change during the course of a day.

To assess the influence of memory accessibility on ACDC's behavior, experiments are conducted where the traffic rate is fixed to 15,000 flows/second and incrementally increase the memory available to ACDC. Note that the selection of the fixed traffic rate is arbitrary as the goal of this experimental setup is to to isolate and discern the relationship between memory availability and the framework's behavior. In all subsequent results, the classification throughput maintains a consistent 100% of the incoming traffic rate. Experiments are conducted both with and without implementing a minimum performance requirement.

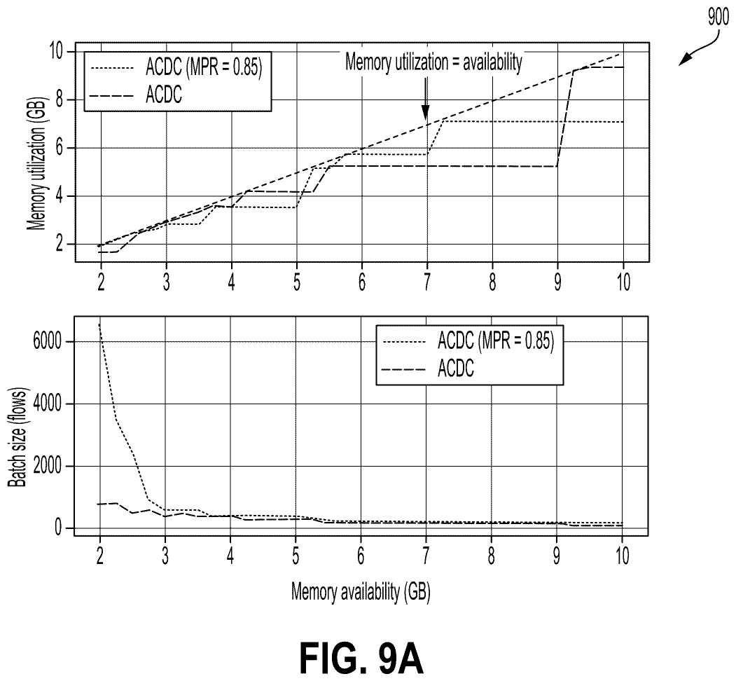

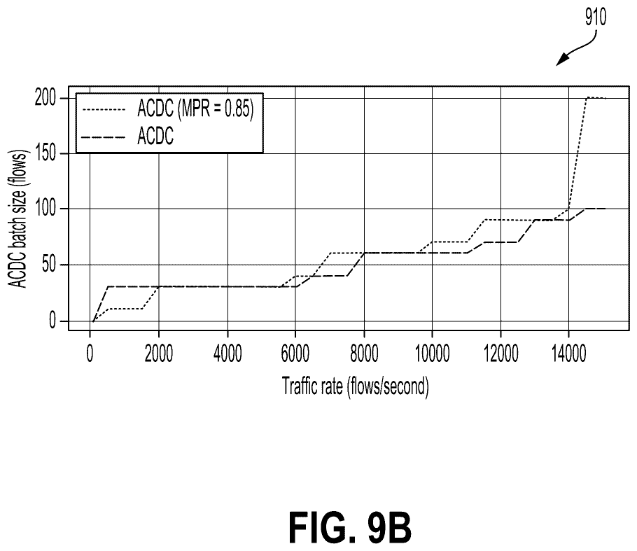

As depicted in graph 900 of FIG. 9A, regardless of whether the minimum performance requirement is set, ACDC exhibits gradual increases in memory utilization and reductions in batch size as the system memory availability increases. This behavior aligns with the adaptive scheduler's objective to maximize the performance-to-TTD ratio because reducing the batch size and choosing classifiers with smaller feature requirements can both lead to a decrease in TTD. However, to this behavior follows an increase in memory requirements, as a reduced batch size results in a higher number of concurrent classifiers.

It is also observed that the selected batch sizes are generally larger when a minimum performance requirement of 0.85 in F1 score is introduced. In this case, the classifier selection process becomes less flexible due to the necessity of selecting classifiers with better performance and, consequentially, higher unit memory requirement per classifier instance. As a result, the framework opts for larger batch sizes to reduce the number of concurrently running instances and to conform to the memory availability.

Following the same approach, the effects of traffic rate on ACDC are examined by gradually increasing the traffic rate from 100 to 15,000 flows/second while fixing the memory availability at an indicative capacity of 10 GB (similar results can be observed at different memory capacities). As shown in graph 910 of FIG. 9B, the adaptive classification framework increases its batch size as the traffic rate grows. This confirms that the ACDC is operating as expected.

Increasing traffic rate continuously with no additional memory resources can result in an increased number of concurrently running classifier instances that will eventually violate the memory availability. As the adaptive scheduler imposes a hard constraint on conforming to current memory availability, it addresses the issue by increasing the batch size and thus reducing the number of concurrently running classifier instances to meet the memory constraint. And, following the same line of reasoning from above, the batch sizes are comparatively higher when a minimum performance requirement is added to compensate for the higher feature requirements and memory consumption in the selected classifiers.

### IV. Example Operations

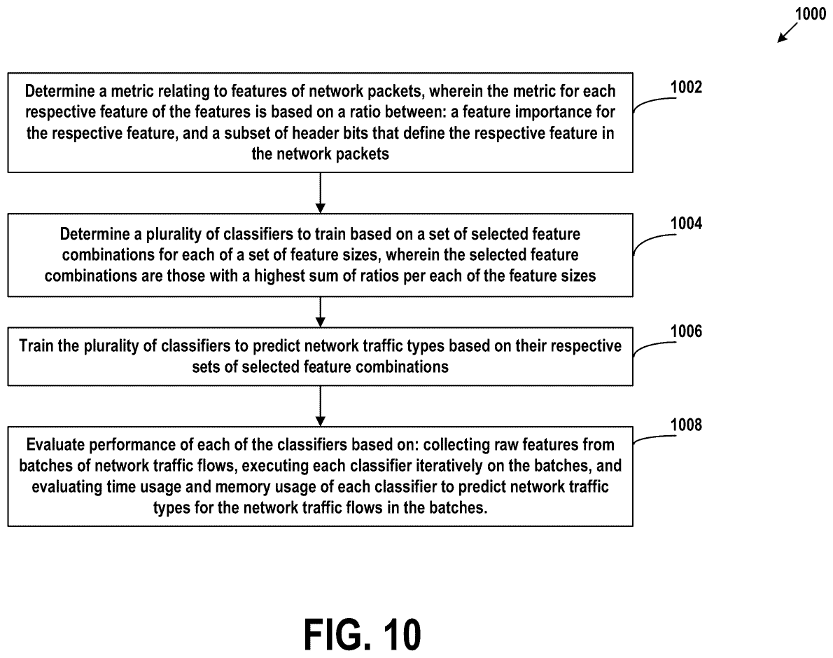

FIG. 10 is a flow chart 1000 illustrating an example embodiment. The process illustrated by FIG. 10 may be carried out by a computing device and/or a cluster of computing devices. However, the process can be carried out by other types of devices or device subsystems. The embodiments of FIG. 10 may be simplified by the removal of any one or more of the features shown therein. Further, these embodiments may be combined with features, aspects, and/or implementations of any of the previous figures or otherwise described herein.

Block 1002 may involve determining a metric relating to features of network packets, wherein the metric for each respective feature of the features is based on a ratio between: a feature importance for the respective feature, and a subset of header bits that define the respective feature in the network packets.

Block 1004 may involve determining a plurality of classifiers to train based on a set of selected feature combinations for each of a set of feature sizes, wherein the selected feature combinations are those with a highest sum of ratios per each of the feature sizes.

Block 1006 may involve training the plurality of classifiers to predict network traffic types based on their respective sets of selected feature combinations.

Block 1008 may involve evaluating performance of each of the classifiers based on: collecting raw features from batches of network traffic flows, executing each classifier iteratively on the batches, and evaluating time usage and memory usage of each classifier to predict network traffic types for the network traffic flows in the batches.

Some embodiments may further involve: selecting a classifier from the plurality of classifiers based on: a network traffic rate, an amount of available memory, and the time usage and the memory usage of the classifier; and deploying the classifier in a network.

Some embodiments may further involve: selecting a second classifier from the plurality of classifiers based on: an update to the network traffic rate, an update to the amount of available memory, and the time usage and the memory usage of the second classifier; and deploying the second classifier in the network as a replacement of the classifier.

In some embodiments, deploying the classifier in the network comprises placing the classifier in the network so that it can: receive incoming network traffic flows, and classify the incoming network traffic flows into the network traffic types.

In some embodiments, selecting the classifier comprises: removing from consideration any classifier of the plurality of classifiers with memory usage above the amount of available memory; and selecting the classifier from one or more remaining classifiers as having a highest performance.

In some embodiments, the classifiers are based on gradient-boosted decision trees.

In some embodiments, the batches have respective sizes measured as a number of network traffic flows.

In some embodiments, evaluating the performance of each of the classifiers comprises varying the respective sizes of the batches.

In some embodiments, the subset of header bits that define the respective feature are associated with a field within headers of the network packets.

In some embodiments, each feature size of the set of feature sizes defines a number of the features.

In some embodiments, executing each classifier iteratively on the batches comprises executing each classifier in response to a batch of the network traffic flows being accumulated.

In some embodiments, training the plurality of classifiers to predict the network traffic types comprises carrying out supervised learning for the classifiers on a network traffic flow test set.

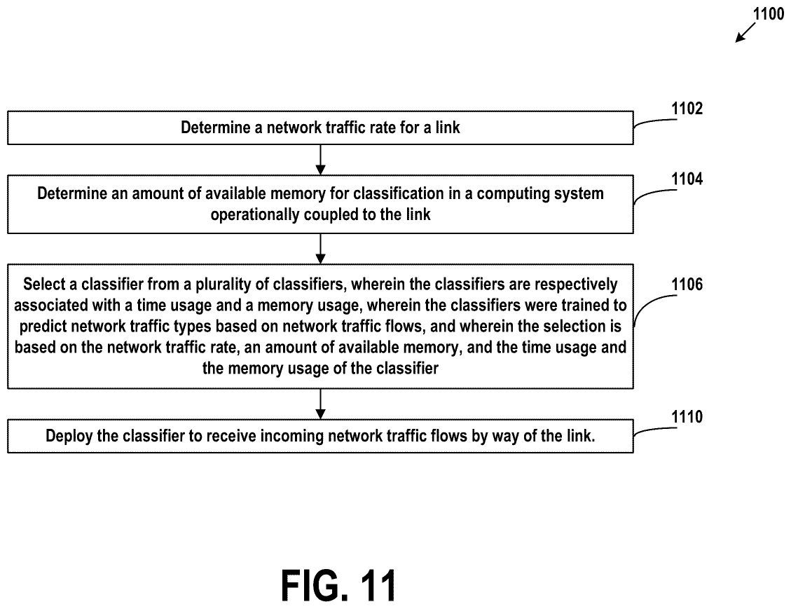

FIG. 11 is a flow chart 1100 illustrating an example embodiment. The process illustrated by FIG. 11 may be carried out by a computing device and/or a cluster of computing devices. However, the process can be carried out by other types of devices or device subsystems. The embodiments of FIG. 11 may be simplified by the removal of any one or more of the features shown therein. Further, these embodiments may be combined with features, aspects, and/or implementations of any of the previous figures or otherwise described herein.

Block 1102 may involve determining a network traffic rate for a link.

Block 1104 may involve determining an amount of available memory for classification in a computing system operationally coupled to the link.

Block 1106 may involve selecting a classifier from a plurality of classifiers, wherein the classifiers are respectively associated with a time usage and a memory usage, wherein the classifiers were trained to predict network traffic types based on network traffic flows, and wherein the selection is based on: the network traffic rate, an amount of available memory, and the time usage and the memory usage of the classifier.

Block 1108 may involve deploying the classifier to receive incoming network traffic flows by way of the link.

Some embodiments may further involve obtaining, from the classifier, predictions of the network traffic types of the incoming network traffic flows.

In some embodiments, obtaining the predictions of the network traffic types of the incoming network traffic flows comprises executing the classifier in response to a batch of the incoming network traffic flows being accumulated.

In some embodiments, the batch has a size measured as a number of network traffic flows.

Some embodiments may further involve: determining an update to the network traffic rate; determining an update to amount of available memory; selecting a second classifier from the plurality of classifiers, wherein the selection is based on: the network traffic rate as updated, the amount of available memory as updated, and the time usage and the memory usage of the second classifier; and deploying the second classifier to receive further incoming network traffic flows by way of the link.

In some embodiments, selecting the classifier comprises: removing from consideration any classifier of the plurality of classifiers with memory usage above the amount of available memory; and selecting the classifier from one or more remaining classifiers as having a highest performance.

In some embodiments, the classifiers are based on gradient-boosted decision trees.

### V. Example Computing Devices and Cloud-Based Computing Environments

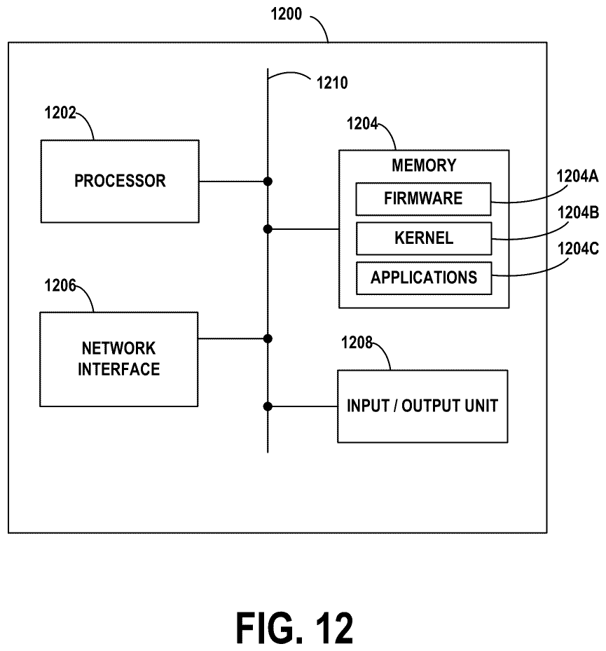

FIG. 12 is a simplified block diagram exemplifying a computing device 1200, illustrating some of the components that could be included in a computing device arranged to operate in accordance with the embodiments herein. Computing device 1200 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 1200 includes processor 1202, memory 1204, network interface 1206, and input/output unit 1208, all of which may be coupled by system bus 1210 or a similar mechanism. In some embodiments, computing device 1200 may include other components and/or peripheral devices (e.g., detachable storage, printers, and so on).

Processor 1202 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 1202 may be one or more single-core processors. In other cases, processor 1202 may be one or more multi-core processors with multiple independent processing units. Processor 1202 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 1204 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 1204 represents both main memory units, as well as long-term storage. Herein, any non-volatile memory may be referred to as persistent storage.

Memory 1204 may store program instructions and/or data on which program instructions may operate. By way of example, memory 1204 may store these program instructions on a non-transitory, computer-readable medium, such that the instructions are executable by processor 1202 to carry out any of the methods, processes, or operations disclosed in this specification or the accompanying drawings.

As shown in FIG. 12, memory 1204 may include firmware 1204A, kernel 1204B, and/or applications 1204C. Firmware 1204A may be program code used to boot or otherwise initiate some or all of computing device 1200. Kernel 1204B may be an operating system, including modules for memory management, scheduling and management of processes, input/output, and communication. Kernel 1204B may also include device drivers that allow the operating system to communicate with the hardware modules (e.g., memory units, networking interfaces, ports, and buses) of computing device 1200. Applications 1204C may be one or more user-space software programs, such as web browsers or email clients, as well as any software libraries used by these programs. Memory 1204 may also store data used by these and other programs and applications.

Network interface 1206 may take the form of one or more wireline interfaces, such as Ethernet (e.g., Fast Ethernet, Gigabit Ethernet, 10 Gigabit Ethernet, Ethernet over fiber, and so on). Network interface 1206 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 1206 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 1206. Furthermore, network interface 1206 may comprise multiple physical interfaces. For instance, some embodiments of computing device 1200 may include Ethernet, BLUETOOTH®, and Wifi interfaces.

Input/output unit 1208 may facilitate user and peripheral device interaction with computing device 1200. Input/output unit 1208 may include one or more types of input devices, such as a keyboard, a mouse, a touch screen, and so on. Similarly, input/output unit 1208 may include one or more types of output devices, such as a screen, monitor, printer, and/or one or more light emitting diodes (LEDs). Additionally or alternatively, computing device 1200 may communicate with other devices using a universal serial bus (USB) or high-definition multimedia interface (HDMI) port interface, for example.

In some embodiments, one or more computing devices like computing device 1200 may be deployed. The exact physical location, connectivity, and configuration of these computing devices may be unknown and/or unimportant to client devices. Accordingly, the computing devices may be referred to as “cloud-based” devices that may be housed at various remote data center locations.

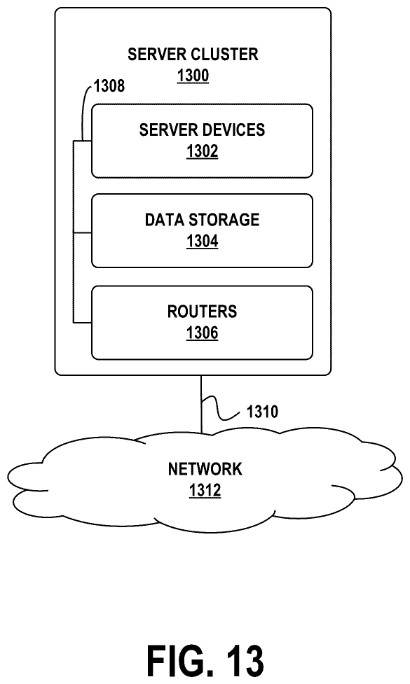

FIG. 13 depicts a cloud-based server cluster 1300 in accordance with example embodiments. In FIG. 13, operations of a computing device (e.g., computing device 1200) may be distributed between server devices 1302, data storage 1304, and routers 1306, all of which may be connected by local cluster network 1308. The number of server devices 1302, data storages 1304, and routers 1306 in server cluster 1300 may depend on the computing task(s) and/or applications assigned to server cluster 1300.

For example, server devices 1302 can be configured to perform various computing tasks of computing device 1300. Thus, computing tasks can be distributed among one or more of server devices 1302. To the extent that these computing tasks can be performed in parallel, such a distribution of tasks may reduce the total time to complete these tasks and return a result. For purposes of simplicity, both server cluster 1300 and individual server devices 1302 may be referred to as a “server device.” This nomenclature should be understood to imply that one or more distinct server devices, data storage devices, and cluster routers may be involved in server device operations.

Data storage 1304 may be data storage arrays that include drive array controllers configured to manage read and write access to groups of hard disk drives and/or solid state drives. The drive array controllers, alone or in conjunction with server devices 1302, may also be configured to manage backup or redundant copies of the data stored in data storage 1304 to protect against drive failures or other types of failures that prevent one or more of server devices 1302 from accessing units of data storage 1304. Other types of memory aside from drives may be used.

Routers 1306 may include networking equipment configured to provide internal and external communications for server cluster 1300. For example, routers 1306 may include one or more packet-switching and/or routing devices (including switches and/or gateways) configured to provide (i) network communications between server devices 1302 and data storage 1304 via local cluster network 1308, and/or (ii) network communications between server cluster 1300 and other devices via communication link 1310 to network 1312.

Additionally, the configuration of routers 1306 can be based at least in part on the data communication requirements of server devices 1302 and data storage 1304, the latency and throughput of the local cluster network 1308, the latency, throughput, and cost of communication link 1310, and/or other factors that may contribute to the cost, speed, fault-tolerance, resiliency, efficiency, and/or other design goals of the system architecture.

As a possible example, data storage 1304 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 1304 may be monolithic or distributed across multiple physical devices.

Server devices 1302 may be configured to transmit data to and receive data from data storage 1304. This transmission and retrieval may take the form of SQL queries or other types of database queries, and the output of such queries, respectively. Additional text, images, video, and/or audio may be included as well. Furthermore, server devices 1302 may organize the received data into web page or web application representations. Such a representation may take the form of a markup language, such as HTML, XML, JSON, or some other standardized or proprietary format. Moreover, server devices 1302 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### VI. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computer-implemented method comprising:
determining a metric relating to features of network packets, wherein the metric for each respective feature of the features is based on a ratio between: a feature importance for the respective feature, and a subset of header bits that define the respective feature in the network packets;
determining a plurality of classifiers to train based on a set of selected feature combinations for each of a set of feature sizes, wherein the selected feature combinations are those with a highest sum of ratios per each of the feature sizes;
training the plurality of classifiers to predict network traffic types based on their respective sets of selected feature combinations; and
evaluating performance of each of the classifiers based on: collecting raw features from batches of network traffic flows, executing each classifier iteratively on the batches, and evaluating time usage and memory usage of each classifier to predict network traffic types for the network traffic flows in the batches.

2. The computer-implemented method of claim 1, further comprising:
selecting a classifier from the plurality of classifiers based on: a network traffic rate, an amount of available memory, and the time usage and the memory usage of the classifier; and
deploying the classifier in a network.

3. The computer-implemented method of claim 2, further comprising:
selecting a second classifier from the plurality of classifiers based on: an update to the network traffic rate, an update to the amount of available memory, and the time usage and the memory usage of the second classifier; and
deploying the second classifier in the network as a replacement of the classifier.

4. The computer-implemented method of claim 2, deploying the classifier in the network comprises:
placing the classifier in the network so that it can: receive incoming network traffic flows, and classify the incoming network traffic flows into the network traffic types.

5. The computer-implemented method of claim 2, wherein selecting the classifier comprises:
removing from consideration any classifier of the plurality of classifiers with memory usage above the amount of available memory; and
selecting the classifier from one or more remaining classifiers as having a highest performance.

6. The computer-implemented method of claim 1, wherein the classifiers are based on gradient-boosted decision trees.

7. The computer-implemented method of claim 1, wherein the batches have respective sizes measured as a number of network traffic flows.

8. The computer-implemented method of claim 7, wherein evaluating the performance of each of the classifiers comprises varying the respective sizes of the batches.

9. The computer-implemented method of claim 1, wherein the subset of header bits that define the respective feature are associated with a field within headers of the network packets.

10. The computer-implemented method of claim 1, wherein each feature size of the set of feature sizes defines a number of the features.

11. The computer-implemented method of claim 1, wherein executing each classifier iteratively on the batches comprises:
executing each classifier in response to a batch of the network traffic flows being accumulated.

12. The computer-implemented method of claim 1, wherein training the plurality of classifiers to predict the network traffic types comprises:
carrying out supervised learning for the classifiers on a network traffic flow test set.

13. A computer-implemented method comprising:
determining a network traffic rate for a link;
determining an amount of available memory for classification in a computing system operationally coupled to the link;
selecting a classifier from a plurality of classifiers, wherein the classifiers are respectively associated with a time usage and a memory usage, wherein the classifiers were trained to predict network traffic types based on network traffic flows, and wherein the selection is based on: the network traffic rate, an amount of available memory, and the time usage and the memory usage of the classifier; and
deploying the classifier to receive incoming network traffic flows by way of the link.

14. The computer-implemented method of claim 13, further comprising:
obtaining, from the classifier, predictions of the network traffic types of the incoming network traffic flows.

15. The computer-implemented method of claim 14, wherein obtaining the predictions of the network traffic types of the incoming network traffic flows comprises:
executing the classifier in response to a batch of the incoming network traffic flows being accumulated.

16. The computer-implemented method of claim 15, wherein the batch has a size measured as a number of network traffic flows.

17. The computer-implemented method of claim 13, further comprising:
determining an update to the network traffic rate;
determining an update to amount of available memory;
selecting a second classifier from the plurality of classifiers, wherein the selection is based on: the network traffic rate as updated, the amount of available memory as updated, and the time usage and the memory usage of the second classifier; and
deploying the second classifier to receive further incoming network traffic flows by way of the link.

18. The computer-implemented method of claim 13, wherein selecting the classifier comprises:
removing from consideration any classifier of the plurality of classifiers with memory usage above the amount of available memory; and
selecting the classifier from one or more remaining classifiers as having a highest performance.

19. The computer-implemented method of claim 13, wherein the classifiers are based on gradient-boosted decision trees.

20. A non-transitory computer-readable medium storing program instructions that, when executed by one or more processors of a computing system, cause the computing system to perform operations comprising:
determining a network traffic rate for a link;
determining an amount of available memory for classification in a computing system operationally coupled to the link;
selecting a classifier from a plurality of classifiers, wherein the classifiers are respectively associated with a time usage and a memory usage, wherein the classifiers were trained to predict network traffic types based on network traffic flows, and wherein the selection is based on: the network traffic rate, an amount of available memory, and the time usage and the memory usage of the classifier; and
deploying the classifier to receive incoming network traffic flows by way of the link.
